(19) United States
(12) Patent Application Publication
(10) Pub. No.: US 2021/0064928 A1
(43) Pub. Date: Mar. 4, 2021

(54) INFORMATION PROCESSING APPARATUS, METHOD, AND NON-TRANSITORY STORAGE MEDIUM

(71) Applicant: NEC CORPORATION, Tokyo (JP)

(72) Inventors: Chaitanya NARISETTY, Tokyo (JP); Reishi KONDO, Tokyo (JP); Tatsuya KOMATSU, Tokyo (JP)

(73) Assignee: NEC CORPORATION, Tokyo (JP)

(21) Appl. No.: 16/969,868

(22) PCT Filed: Feb. 16, 2018
(86) PCT No.: PCT/JP2018/005455

§ 371 Date: Aug. 13, 2020

(51) Int. Cl. G06K 9/62

(52) U.S. Cl. CPC G06K 9/6256; G06K 9/6218; G06K 9/6285

(57) ABSTRACT

The information processing apparatus acquires a plurality of training data, extracts feature data from each training data, and divides the training data using the extracted feature data into a plurality of data clusters. The information processing apparatus performs for each data cluster: extracting a feature matrix from the training data in the data cluster; and perform matrix decomposition on the feature matrix to generate a first basis matrix. The information processing apparatus performs dimensionality reduction on a concatenation of a plurality of the first basis matrices to generate a second basis matrix. The information processing apparatus performs matrix decomposition on a concatenation of a plurality of the feature matrices using the second basis matrix, thereby generating an activations matrix.

### TECHNICAL FIELD

Embodiments of the invention generally relate to the field of model training in machine learning.

### BACKGROUND ART

The wide and ever growing interest in pattern recognition mainly stems from its applicability to applications relating to security, medical science, recognition of image, text, speech to name a few. In general, these applications utilize machine learning techniques to learn data patterns and then are able to detect and identify them. One of the well-known techniques for learning data patterns is the Matrix Decomposition, especially Non-Negative Matrix Factorization, and used frequently in image and speech related applications. An example of such an application is the Acoustic Event Detection where audio patterns are first learnt and then detected in any given audio data input. This process of learning and detecting will be referred from here on in the present invention as training and testing respectively.

Broadly speaking, during the training process, a few patterns or features are extracted from the training data input and models are trained over them. During the testing process, similar features are extracted from the testing data input and the trained models detect if these features match the training data features. This training and testing processes are not limited to only one type or class of data inputs. The models can also be trained to classify among different types or classes of data inputs.

The training data for a class can be obtained from different types of sources or instances. For example, in the data input of Shouting, it is possible to have 100 audio samples of men shouting and only 1 audio sample of a woman shouting. This creates the problem of data imbalance. This problem can also arise from different class sizes. An example is a data input with 100 pictures of class: Cats and only 10 pictures of class: Dogs.

Many of the models are generally trained using the entire data of each class or the entire data of all the classes. When performing such model training, it is being assumed that the data of each class and the data of all the classes are balanced. One possible way of satisfying this assumption is to make databases of data to be used, e.g. images, audio or text, so as to have equal number of instances of all types of sources of a class and to have equal number of total instances for all types of classes. However, such constraints are difficult to uphold.

So to overcome them, a technique commonly used is to cluster the features of the data input into subsets, and modeling each subset, thereby generating a mixture model. At its core, a mixture model represents the feature subsets present inside the overall set of features. An example is the Gaussian Mixture Model with the number of mixtures as its latent variable.

A prior art for this method is described in NPL 1. In the training phase, feature vectors are extracted from training data, and they are clustered into a set of feature vector clusters. Model parameter generated through training over the set of feature vector clusters using the data labels of the training data. The generated model parameters are stored so as to be used in the testing phase. In the testing phase, the feature vectors are extracted from the testing data, and the testing data is identified by matching its testing feature vectors using the model parameters.

Estimating the exact number of clusters for each set of feature vectors is important to not over-fit or under-fit the model. If the exact number of clusters is specified, then the model will overcome the data imbalance and will cluster the training data effectively. However, when the training data is considerably large and/or if there are correlated events/classes, the training feature vectors tend to have many correlations. Such clustering methods are not suitable for extracting the correlations present among the feature vectors of different classes or extracting the correlations among the feature vectors of different clusters of a particular class. Note that the words ‘event’ and ‘class’ are used interchangeably throughout this patent.

Matrix Decomposition estimates such correlations present in the series data when represented as a feature matrix (a set of feature vectors). Define the feature matrix (V) as a set of N feature vectors {vi}, 1<=i<=N. The decomposition of the feature vectors is:

Equation 1

vᵢ≅w₁h₁ᵢ+w₂h₂ᵢ+ . . . +w_{K}h_{Ki} (1)

where each vector vi is approximated as a linear combination of the basis vectors {wk}, 1<=i<=N.

Generally, k is much smaller than N. This means that only a few basis vectors are sufficient to estimate the feature matrix V. The set of basis vectors is the basis matrix (W) and H={Hkj}, 1<=k<=K, 1<=i<=N is set of activations or the activations matrix. More concisely, V is decomposed as follows.

Equation 2

V≅WH (2)

where the sign in the above equation represents approximate equality.

One of the popular examples of Matrix Decomposition is the Non-Negative Matrix Factorization (NMF). When W is fixed in NMF, it is termed as Supervised NMF. If W is estimated using NMF with and without prior information, it is termed as Semi-Supervised and Un-Supervised respectively.

The prior art NPL 2 which takes the above-mentioned correlations into account, uses the concept of Non-Negative Matrix Factorization. In the training phase, feature vectors are extracted from the training data, and they are decomposed into a basis matrix and an activations matrix. Model parameters are generated through training over the activations matrix using the data labels of the training data. In the testing phase, the feature vectors are extracted from the testing data, and they are decomposed into an activations matrix with the basis matrix fixed as that generated in the training phase. The testing data is identified by matching its activations matrix using the model parameters.

### CITATION LIST

### Non Patent Literature

[NPL 1] Vuegen, L., et al., “An MFCC-GMM approach for event detection and classification,” IEEE Workshop on Applications of Signal Processing to Audio and Acoustics (WASPAA), 2013.
[NPL 2] Ludena-Choez, Jimmy, and Ascension Gallardo-Antolin, “NMF-based spectral analysis for acoustic event classification tasks,” International Conference on Nonlinear Speech Processing, 2013.

### SUMMARY OF INVENTION

### Technical Problem

NPL 1 handles the problem of data imbalance by performing a clustering of the features. However, it does not take into account the correlations present between a pair of clusters. This leads to an inadequate modeling of the overall training data.

NPL 2 handles the problem of correlations among training data by performing un-supervised decomposition to estimate its basis and activations matrices. Such matrix decomposition is performed so as to minimize the cost function for the entire data. However the cost function for matrix decompositions gives equal priority to all feature vectors in the training data. So when there is redundancy in the training data, the estimated basis vectors are focused on minimizing the cost function of the larger subsets of training data, thereby ignoring the smaller subsets.

The objective of the present invention is to provide a novel way of obtaining better representation of training data taking into account both the data imbalance and correlations among training data.

### Solution to Problem

The present invention provides an information processing apparatus comprising: 1) a clustering unit acquiring a plurality of training data, extracting feature data from each training data, and dividing the plurality of training data using the extracted feature data into a plurality of data clusters; 2) a first decomposition unit performing for each data cluster: extracting a feature matrix from the training data in the data cluster; and perform matrix decomposition on the feature matrix to generate a first basis matrix; 3) a dimensionality reduction unit performing dimensionality reduction on a concatenation of a plurality of the first basis matrices to generate a second basis matrix; and 4) a second decomposition unit performing matrix decomposition on a concatenation of a plurality of the feature matrices using the second basis matrix, thereby generating an activations matrix.

The present invention provides a method performed by a computer. This method comprises: 1) acquiring a plurality of training data, extracting feature data from each training data, and dividing the plurality of training data using the extracted feature data into a plurality of data clusters; 2) performing for each data cluster: extracting a feature matrix from the training data in the data cluster; and perform matrix decomposition on the feature matrix to generate a first basis matrix; 3) performing dimensionality reduction on a concatenation of a plurality of the first basis matrices to generate a second basis matrix; and 4) performing matrix decomposition on a concatenation of a plurality of the feature matrices using the second basis matrix, thereby generating an activations matrix.

The present invention provides a program causing a computer to execute each step of the method provided by the present invention.

### Advantageous Effects of Invention

In accordance with the present invention, a novel way of obtaining better representation of training data taking into account both the data imbalance and correlations among training data.

### BRIEF DESCRIPTION OF DRAWINGS

The above-mentioned objects, other objects, features and advantages will be made clearer from the preferred example embodiments described below, and the following accompanying drawings.

FIG. 1 illustrates an overview of how the information processing apparatus of the example embodiment 1 works.

FIG. 2 is a block diagram illustrating a function-based configuration of the information processing apparatus 2000 of Example Embodiment 1.

FIG. 3 is a block diagram illustrating an example of hardware configuration of a computer 1000 realizing the information processing apparatus 2000 of Example Embodiment 1.

FIG. 4 is a flow chart illustrating a flow of processes executed by the information processing apparatus 2000 of Example Embodiment 1.

FIG. 5 illustrates clustering performed for each event.

### DESCRIPTION OF EMBODIMENTS

Hereinafter, example embodiments of the present invention will be described with reference to the accompanying drawings. In all the drawings, like elements are referenced by like reference numerals and the descriptions thereof will not be repeated.

### Example Embodiment 1

### Overview

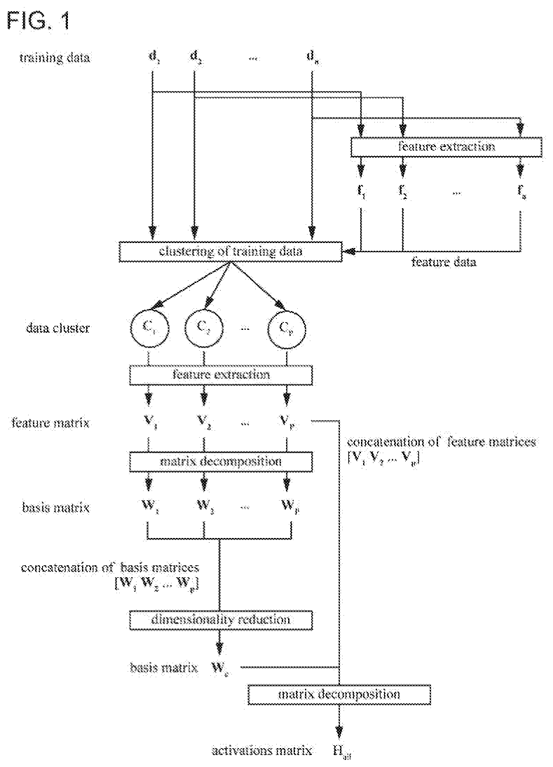

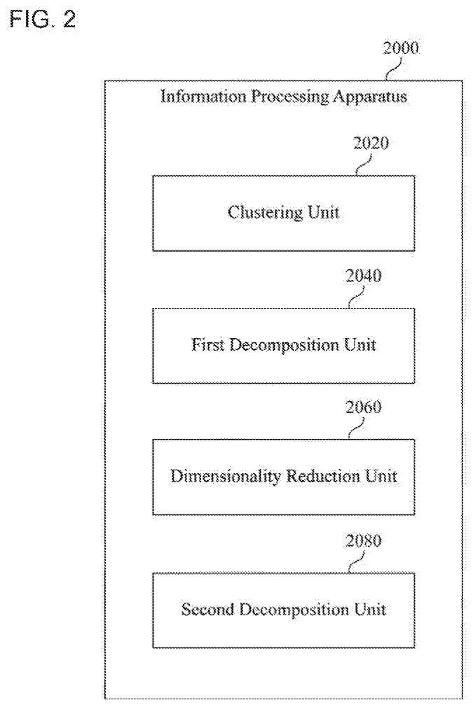

FIG. 1 illustrates an overview of how the information processing apparatus of Example Embodiment 1 (illustrated as the information processing apparatus 2000 in FIG. 2) works. The information processing apparatus 2000 acquires a plurality of training data. For each training data, the information processing apparatus 2000 extracts feature data relevant to the training data. The feature data can vary from a single dimensional value to a multi-dimensional vector depending on the type of feature.

The information processing apparatus 2000 divides the plurality of the training data using the extracted feature data into data clusters. For each data cluster, the information processing apparatus 2000 extracts feature matrix from the training data in the data cluster and performs matrix decomposition on the feature matrix. As a result, the first basis matrix, i.e. a set of basis vectors, is generated for each data cluster. The information processing apparatus 2000 concatenates the generated first basis matrices into a single matrix, performs dimensionality reduction on the concatenation of the first basis matrices, and thereby generating the second basis matrix.

Using the second basis matrix, the information processing apparatus 2000 performs matrix decomposition again. This matrix decomposition is performed on the concatenation of all of feature matrices generated from the data clusters. As a result of this matrix decomposition, an activations matrix is generated. This activations matrix is to be used to generate model parameters for a testing phase of pattern recognition.

### Advantageous Effect

According to the information processing apparatus 2000 of Example Embodiment 1, the plurality of feature data extracted from training data is used and the training data are divided into the plurality of data clusters, feature matrix is extracted from each data cluster, and matrix decomposition is performed for each feature matrix. By performing this matrix decomposition for each data cluster, the influence of data imbalance on matrix decomposition is alleviated.

In addition, correlations between training data are effectively removed thorough matrix decomposition and dimensionality reduction. Specifically, correlations between feature vectors in the same data cluster are reduced through the matrix decomposition performed for each data cluster. In terms of the dimensionality reduction, it reduces correlations between features in different data clusters.

Finally, the activations matrix to be used in model training is generated through matrix decomposition on the feature matrices using the second basis matrix (i.e. the output of the above-mentioned dimensionality reduction). As for feature matrices, each of them is effectively extracted with the influence of data imbalance being reduced through clustering as described above. As for the second basis matrix, correlations between training data is well removed as described above. By using such the feature matrices and the second basis matrix, it is achieved to more effective extraction of activations matrix. As a result, better model parameters can be obtained by training over this activations matrix.

In the following descriptions, the detail of the information processing apparatus 2000 of the present Example embodiment will be described.

<Example of Function-Based Configuration>

FIG. 2 is a block diagram illustrating a function-based configuration of the information processing apparatus 2000 of Example Embodiment 1. The information processing apparatus 2000 includes a clustering unit 2020, a first decomposition unit 2040, a dimensionality reduction unit 2060, and a second decomposition unit 2080. The clustering unit 2020 acquires a plurality of training data, extracts feature data from each training data, and divides a plurality of training data using the extracted feature data into a plurality of data clusters. For each data cluster, the first decomposition unit 2040 extracts a feature matrix from the training data in the data cluster, and performs matrix decomposition on the feature matrix to generate the first basis matrix. The dimensionality reduction unit 2060 performs dimensionality reduction on the concatenation of the plurality of the first basis matrices to generate the second basis matrix. The second decomposition unit 2080 performs matrix decomposition on a concatenation of the plurality of the feature matrices using the second basis matrix, thereby generating an activations matrix.

<Example of Hardware Configuration>

In some embodiments, each functional unit included in the information processing apparatus 2000 may be implemented with at least one hardware component, and each hardware component may realize one or more of the functional units. In some embodiments, each functional unit may be implemented with at least one software component. In some embodiments, each functional unit may be implemented with a combination of hardware components and software components.

The information processing apparatus 2000 may be implemented with a special purpose computer manufactured for implementing the information processing apparatus 2000, or may be implemented with a commodity computer like a personal computer (PC), a server machine, or a mobile device.

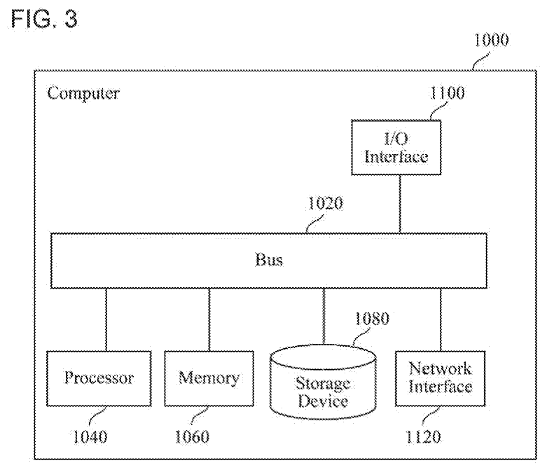

FIG. 3 is a block diagram illustrating an example of hardware configuration of a computer 1000 realizing the information processing apparatus 2000 of Example Embodiment 1. In FIG. 3, the computer 1000 includes a bus 1020, a processor 1040, a memory 1060, a storage device 1080, an input-output (I/O) interface 1100, and a network interface 1120.

The bus 1020 is a data transmission channel in order for the processor 1040, the memory 1060, the storage device 1080, the I/O interface 1100, and the network interface 1120 to mutually transmit and receive data. The processor 1040 is a processor such as CPU (Central Processing Unit), GPU (Graphics Processing Unit), or FPGA (Field-Programmable Gate Array). The memory 1060 is a primary storage device such as RAM (Random Access Memory). The storage medium 1080 is a secondary storage device such as hard disk drive, SSD (Solid State Drive), or ROM (Read Only Memory).

The I/O interface 1100 is an interface between the computer 1000 and peripheral devices, such as keyboard, mouse, or display device. The network interface 1120 is an interface between the computer 1000 and a communication line through which the computer 1000 communicates with another computer.

The storage device 1080 may store program modules, each of which is an implementation of a functional unit of the information processing apparatus 2000 (See FIG. 2). The processor 1040 executes each program module, and thereby realizing each functional unit of the information processing apparatus 2000.

<Flow of Process>

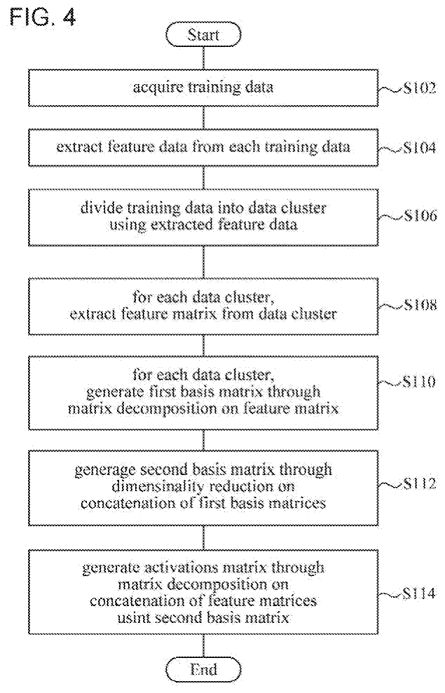

FIG. 4 is a flow chart illustrating a flow of processes executed by the information processing apparatus 2000 of Example Embodiment 1. The clustering unit 2020 obtains a plurality of training data (S102). The clustering unit 2020 extracts feature data from each training data (S104). The clustering unit 2020 divides the training data based on the extracted feature data into a plurality of data clusters (S106). The first decomposition unit 2040 extracts a feature matrix from the training data for each data cluster (S108). For each data cluster, the first decomposition unit 2040 performs matrix decomposition on the concatenation of the feature matrices extracted from the data cluster to thereby generate the first basis matrix (S108). The dimensionality reduction unit 2060 performs dimensionality reduction on the concatenation of the first basis matrices to thereby generate the second basis matrix (S110). The second decomposition unit 2080 performs matrix decomposition on the concatenation of the feature matrices using the second basis matrix to thereby generate an activations matrix (S112).

<Acquisition of Training Data: S102>

The clustering unit 2020 acquires the plurality of training data (S102). They are the series of data points for different events. The training data may be obtained from any means of quantitative data collection, such as sound sensors, vibration sensors, automobile related sensors, chemical sensors, electric sensors, magnetic sensors, radiation sensors, pressure sensors, thermal sensors, optical sensors, navigational sensors and weather sensors.

There are a variety of ways to acquire the training data. In some embodiments, the clustering unit 2020 may acquire the training data from a storage device storing the training data, which may be installed inside or outside the information processing apparatus 2000. In some embodiments, the clustering unit 2020 receives the training data sent from an apparatus that generates the training data.

In some embodiments, the training data may be generated by the information processing apparatus 2000 from source data, such as video data to generate one or more images, or audio data to generate one or more audio samples. The generated training data is written into a storage device, e.g. the storage device 1080. The clustering unit 2020 acquires the training data from that storage device.

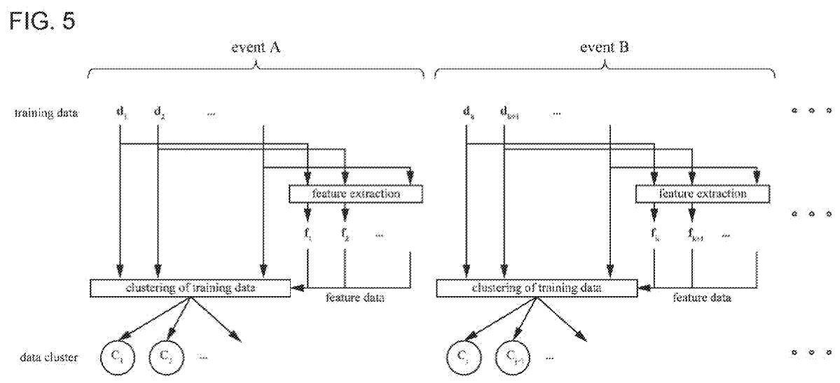

Note that, each training data is classified into one of classes or events in advance. For example, the clustering unit 2020 acquires audio samples tagged with one of audio events like Screaming or Speaking. In this case, the clustering unit 2020 may perform a clustering algorithm for each event. FIG. 5 illustrates clustering performed for each event.

<Feature Extraction: S104>

The clustering unit 2020 extracts feature data relevant to the training data, such as: Mel-Frequency Cepstral Coefficients and Spectrogram for audio data; and intensity and texture for images. There are a variety of well-known techniques to extract feature data from training data, and the clustering unit 2020 may use any of such well-known techniques.

<Clustering of Feature Data: S106>

The clustering unit 2020 divides the training data based on their feature data into a plurality of data clusters (S106). The data clusters are represented as {Cp}, 1<=p<=P, where P denotes the total number of data clusters. The clustering unit 2020 identifies sets of feature data that are similar to each other, and places their corresponding training data into the same data cluster. These set of data clusters {Cp} are similar to the ones in NPL 1, where each cluster has a model and their mixture model was used as the training model for the training data acquired.

The clustering unit 2020 may use supervised, semi-supervised or un-supervised clustering techniques. For example, however not limited to, multi-variate Gaussian, k-means or hierarchical clustering methods may be used.

<Correlation Extraction>

The information processing apparatus 2000 extracts the correlations and identifies the variability among the set of data clusters with the first decomposition unit 2040 and the dimensionality reduction unit 2060. The correlation extraction is realized by modeling the individual features of each data cluster as a linear combination of a fewer latent or unobserved variables. When there are many data clusters, this in turn leads to many latent variables. Many latent variables again raise the problem of correlations among them. So, dimensionality is further reduced by identifying a more compact representation of latent variables estimated from the entire set of latent variables of each data cluster. These compact set of latent variables represent all the data clusters without any bias for the cluster size. This implies the compact set of latent variables can represent all of the training data efficiently.

<<Feature Extraction: S108>>

The first decomposition unit 2040 extracts feature vectors for each data cluster, thereby generating a feature matrix {Vp}, 1<=p<=P, for each data cluster Cp. Specifically, the feature matrix Vp is a concatenation of the feature vectors extracted from the training data in the data cluster Cp. This feature extraction is similar to that performed by the clustering unit 2020 in the sense that the features are relevant to the type of training data. However the difference being that these features of data clusters are used for matrix decompositions. So it is essential for the features to be vectors with at least two dimensions.

There are two feature extraction steps S104 and S108 in the overall process flow chart illustrated in FIG. 4 which warrants the need to differentiate their necessity. The feature data extracted in S104 are features favorable for clustering techniques. In other words, the extracted feature data must be efficient in extracting meaningful clusters. An example features predominantly used for Gaussian Mixture Model based clustering of audio data are the Mel-Frequency Cepstral Coefficients (MFCC). However the features matrices extracted from the data clusters in S108 are features efficient for matrix decomposition techniques. Power spectrogram matrices are one of popular features extracted from audio data and used in the Non-Negative Matrix Factorization techniques to extract low-rank latent factors (Basis and Activation matrices).

<<First Matrix Decomposition: S110>>

The first decomposition unit 2040 decomposes each of the feature matrices, and thereby generating their respective first basis matrices (S110). Hereinafter, the first basis matrix generated from the feature matrix {Vp} is denoted as {Wp}. In addition, matrix decomposition performed by the first decomposition unit 2040 is described as “first matrix decomposition” in order to distinguish it from matrix decomposition performed by the second decomposition unit 2080.

Most matrix decompositions iteratively update the basis and the activation matrices until the cost function is minimized. For un-supervised cases, the basis matrix and the activation matrix are generally initialized with random values and then iteratively updated. Since each data cluster Cp is estimated so that all of the data points within the cluster Cp are similar to each other, it is intuitive that Wp is an efficient representation of Cp.

There are a variety of techniques of matrix decomposition. The first decomposition unit 2040 may use any of the unsupervised matrix decomposition techniques, such as Principal Component Analysis (PCA), Independent Component Analysis (ICA), Non-Negative Matrix Factorization (NMF), Eigen value decomposition (EVD) and Singular value decomposition (SVD).

<<Dimensionality Reduction: S112>>

The dimensionality reduction unit 2060 concatenates the plurality of the first basis matrices into a single matrix, and performs dimensionality reduction on the concatenation of the first basis matrices to thereby generate the second basis matrix (S112). It is likely that there are many number of data clusters Cp, implying that there are many number of basis matrices Wp, thereby implying many more overall basis vectors; the total number of basis vectors is the total number of columns of all the basis matrices. This implies that there are correlations among the basis matrices Wp as well. Therefore, there may still be a room for reducing redundancy from the first basis matrices.

One possible way of reducing redundancy in the basis vectors is to find a smaller set of basis vectors that are able to represent the overall set of basis matrices Wall, which is the horizontal concatenation of all the first basis matrices as follows:

Equation 3

Wₐₗₗ=[W₁W₂ . . . Wₚ . . . W_{P}] (3)

The dimensionality reduction unit 2060 combines the first basis matrices {Wp} into a single matrix Wall by horizontally concatenating them, and generates Wc from Wall by performing dimensionality reduction on Wall; the dimensionality of Wc is less than that of Wall. There are a variety of techniques of dimensionality reduction, such as PCA, NMF, Kernel PCA, Graph-based kernel PCA, Linear Discriminant Analysis (LDA) and Generalized Discriminant Analysis (GDA). The dimensionality reduction unit 2060 may use any of these techniques.

<Second Matrix Decomposition: S114>

The second decomposition unit 2080 combines the feature matrices {Vp} of the plurality of data clusters {Cp} into a single matrix Vall, and decomposes Vall using the second basis matrix Wc to thereby generate an activations matrix (S114). Vall is the horizontal concatenation of all the feature matrices as follows:

Equation 4

Vₐₗₗ=[V₁V₂ . . . Vₚ . . . V_{P}] (4)

In this example embodiment, the second decomposition unit 2080 performs supervised decomposition by fixing basis matrix as We generated by the dimensionality reduction unit 2060. Note that, hereinafter, matrix decomposition performed by the second decomposition unit 2080 is described as “second matrix decomposition” in order to distinguish that performed by the first decomposition unit 2040, i.e. first matrix decomposition. Through the second matrix decomposition, activations matrix Hall is estimated such that:

Equation 5

Vₐₗₗ≅W_{C}Hₐₗₗ (5)

Since the basis matrix is fixed, the second decomposition unit 2080 iteratively updates only the activations matrix through, for example, minimization of the cost function. The activations matrix Hall is a set of activations vectors.

There are a variety of supervised matrix decomposition techniques, such as Support Vector Machines (SVM), neural networks, thresholding, Decision Trees, k-nearest neighbors, Bayesian networks, Logistic Regression and Random Forests. The second decomposition unit 2080 may use any of the supervised matrix decomposition techniques.

<Application of Information Processing Apparatus 2000>

The data imbalance is predominant in the audio, image and video processing fields. As an example application of the information processing apparatus of Example Embodiment 1, audio event detection (training and detection of distinct audio events) is illustrated below. Note that, the following example does not limit the scope of the present invention.

Consider the application of training 4 types of audio events for their identification and detection in any given audio signal. Let the 4 events be Screaming, Speaking, Gunshots and Noise. Here, Noise refers to the background audio noises that include neither of screaming, speaking nor gunshots. In this application of event detection, the Noise data serves as an event that is not of interest for detection.

The data imbalance in such audio events occurs mainly due to the variation in audio sources. For example, screaming of men, women, children etc. have different characteristics. Similar is the case of gunshots of a shotgun, handgun etc. The imbalance can come from the redundancy in the data of such audio sources: e.g. event data of Screaming contains 100 samples from children, 10 samples from women and 2 samples from men. Similarly, for each individual event, there can be an unknown number of audio sources and an unknown number of their samples. It is being assumed that the labels of the above mentioned 4 events are known, however the imbalance among the audio sources within each event is not known. Training over such an unbalanced data can result in the overrepresentation of an audio source over the others.

To tackle this problem, the information processing apparatus 2000 of Example Embodiment 1 clusters the event data to roughly estimate the total number of audio sources and their respective samples, with the clustering unit 2020. To identify clusters in audio signals, well-known feature vectors like, however not limited to, Cepstral Coefficients, delta-Cepstral Coefficients, Spectrograms can be used.

Note that, an audio signal is a time-series data and therefore can be split into overlapping windows (windowing process) with each window containing a small number of discrete audio points. A feature vector is a meaningful modified representation of the points in a given window. Frequency in an audio signal is one such well-known meaningful information.

A general notion of the nature of audio data, events and features is given below. An audio signal is a discrete representation of audio. Consider a signal with sampling frequency of 48 kHz, with each sample represented using 16 bits. An audio event is a group of audio samples that can be identified to have a common characteristic. An audio sample for Screaming can be sampled from a 1-2 seconds screaming of a child, woman or man and similar samples can be obtained for other events. The windowing process of an audio sample of 1 second duration with 100 ms window length and 50 ms window shift will output windows of points sampled in 0-100 ms, 50-150 ms, 100-200 ms, c, 900-1000 ms. A Hann window can be used to ensure a smooth start and end for each window. A feature vector of Cepstral Coefficients (CC) can be estimated from each window of points. For practical uses, dimensionality of each CC vector can range from 10 to 15. Based on these feature vectors, the event data can be clustered into a few set of data clusters.

The first decomposition unit 2040 performs matrix decomposition on the feature matrix of each data cluster, thereby extracting simpler representations of the feature matrices, i.e. a set of the first basis matrices. A matrix decomposition technique for spectrogram related feature matrices is the NMF. Since the amplitude of a spectrogram has information of the frequency components present in an audio signal, NMF can be used to extract correlations from the feature matrix. The feature matrix in this application is a set of feature vectors, each of which represents the data points in a window obtained from windowing the audio of each data cluster.

Note that, although the audio sources are distinct (ex: children, women and men), the overall event is Screaming and will have similar characteristics. Therefore correlations among the audio sources must be extracted. This reasoning extends to the correlations among events themselves i.e. the event data of Screaming and Speaking will have some similar characteristics as both events are a form of speech itself.

Once the first basis matrix is extracted for each data cluster, the dimensionality reduction unit 2060 concatenates the first basis matrices {Wp} into a single matrix Wall, performs dimensionality reduction on Wall, and thereby generating the second basis matrix Wc as a simpler representation of the set of first basis matrices {Wp}. Then, the second decomposition unit 2080 generates the activation matrix Hall by performing supervised matrix decomposition on Vall (i.e. the horizontal concatenation of the feature matrices {Vp}) with basis matrix fixed as the second basis matrix Wc. To complete the overall training process, the activation matrix Hall is modeled using the known event labels to obtain model parameters. As a result, the learnt model can classifies audio signal to be tested into one of the trained events—Screaming, Speaking and Gunshots.

To detect and identify the trained events in any given audio signal, the testing phase can be followed. Briefly, the testing process has 3 main steps. First, feature vectors are estimated from the windowed test audio signal. Then the matrix decomposition of the overall feature matrix is done in a supervised manner using the above-mentioned second basis matrix, thereby obtaining an activation matrix. Finally, the obtained activation matrix is then tested for possible detection of Screaming, Speaking and Gunshot events using the model parameters.

### Example Embodiment 2

In Example Embodiment 1, the activation matrix Hall is estimated using supervised matrix decomposition with basis matrix fixed as the second basis matrix Wc, which is the result of dimensionality reduction performed on Wall. Although the second basis matrix Wc is an effective representation of feature vectors, there is still room for refining this basis matrix since it is not direct estimate from Vall but from Wall. Obtaining better basis matrix for the second matrix decomposition results in obtaining better activations matrix Hall.

In order to obtain a more optimal basis matrix and activations matrix, the information processing apparatus 2000 of Example Embodiment 2 performs the second matrix decomposition on the feature matrix Vall without fixing basis matrix as the second basis matrix Wc. Specifically, the second decomposition unit 2080 of Example Embodiment 2 decomposes the feature matrix Vall in a semi-supervised way by initializing the basis matrix as Wc instead of random initialization.

As a result of the semi-supervised matrix decomposition on Vall, the activations matrix Hall is obtained such that:

Equation 6

Vₐₗₗ≅W_{F}Hₐₗₗ (6)

WF is the estimated basis matrix at the end of the cost function minimization by iteratively updating initial basis matrix Wc. Then, training over this obtained Hall is performed to generate model parameters to be used in the test phase.

The second decomposition unit 2080 of Example Embodiment 2 may use any of the semi-supervised matrix decomposition techniques. For example, however not limited to, PCA, ICA, NMF, EVD and SVD.

### Advantageous Effect

If the basis matrix had been initialized randomly in the decomposition of the feature matrix Vall, there is no guarantee that the final obtained basis matrix would represent all the data clusters well due to the data imbalance. On the other hand, according to the information processing apparatus of Example Embodiment 2, the basis matrix is more likely to converge to an optimal basis matrix WF through the semi-supervised decomposition of the Vall with basis matrix initialized as the second basis matrix Wc. This is because Wc represents each cluster fs basis matrix and therefore more approximately represents the features extracted from all the data clusters, at least than randomly initialized matrix.

<Example of Function-Based Configuration>

Similarly to the information processing apparatus 2000 of Example Embodiment 1, the function-based configuration of the information processing apparatus 2000 of Example Embodiment 2 may be described by FIG. 2.

<Example of Hardware Configuration>

A hardware configuration of the information processing apparatus 2000 of Example Embodiment 2 may be illustrated by FIG. 3 similarly to Example Embodiment 1. However, in the present example embodiment, each program module stored in the above-described storage 1080 includes a program for realizing each function described in the present example embodiment.

### Example Embodiment 3

In Example Embodiment 2, the second matrix decomposition is realized as semi-supervised matrix decomposition. In the semi-supervised matrix decomposition, the iterative update step of the basis matrix is dependent on the cost function minimization. Since the cost function is still biased towards the larger data clusters, this bias creeps into the update steps for the basis matrix. This bias will creep in, irrespective of the initialization and therefore affects the final basis matrix obtained at the end of the cost function minimization.

The information processing apparatus 2000 of Example Embodiment 3 alleviates this bias to a certain extent by introducing a normalization of Vall, i.e. the overall set of feature matrices, before their semi-supervised decomposition. Specifically, the second decomposition unit 2080 determines a weight parameter {qp}, 1<=p<=P to each of its respective data clusters {Cp}. The value of the weight parameter qp is chosen such that it is proportional to the weightage of the data cluster Cp over the cost function.

The weights may be assigned using any of the non-decreasing positive weight assignment techniques. For example, however not limited to, data size, singular values, exponentially increasing functions of data size and data volume.

The second decomposition unit generates the feature matrix V′all as the concatenation of the normalized version of feature matrix Vp as follows:

$$\begin{matrix}Equation 7 & \\ {V}_{all}^{′} = [ \frac{{V}_{1}}{{q}_{1}} \frac{{V}_{2}}{{q}_{2}} … \frac{{V}_{p}}{{q}_{p}} … \frac{{V}_{P}}{{q}_{P}} ] & ( 7 )\end{matrix}$$

Based on V′all instead of Vall, the second decomposition unit 2080 performs the second matrix decomposition to generate the second basis matrix WF and the activations matrix Hall, such that:

Equation 8

V′ₐₗₗ≅W_{F}Hₐₗₗ (8)

As described above, although the example embodiments of the present invention have been set forth with reference to the accompanying drawings, these example embodiments are merely illustrative of the present invention, and a combination of the above example embodiments and various configurations other than those in the above-mentioned example embodiments can also be adopted.

### Advantageous Effect

As mentioned above, in the second matrix decomposition, the cost function tends to be biased towards the larger data clusters, and this bias creeps into the update steps for the basis matrix. According to the information processing apparatus 2000 of Example Embodiment 3, this bias is alleviated through the normalization of the feature matrix Vall. Therefore, it is achieved to obtain more optimal second basis matrix WF and activations matrix Hall.

<Example of Function-Based Configuration>

Similarly to the information processing apparatus 2000 of Example Embodiment 2, the function-based configuration of the information processing apparatus 2000 of Example Embodiment 3 may be described by FIG. 2.

<Example of Hardware Configuration>

A hardware configuration of the information processing apparatus 2000 of Example Embodiment 3 may be illustrated by FIG. 3 similarly to Example Embodiment 2. However, in the present example embodiment, each program module stored in the above-described storage 1080 includes a program for realizing each function described in the present example embodiment.

As described above, although the example embodiments of the present invention have been set forth with reference to the accompanying drawings, these example embodiments are merely illustrative of the present invention, and a combination of the above example embodiments and various configurations other than those in the above-mentioned example embodiments can also be adopted.

1. An information processing apparatus comprising:
a clustering unit acquiring a plurality of training data, extracting feature data from each training data, and dividing the plurality of training data using the extracted feature data into a plurality of data clusters;
a first decomposition unit performing for each data cluster: extracting a feature matrix from the training data in the data cluster; and perform matrix decomposition on the feature matrix to generate a first basis matrix;
a dimensionality reduction unit performing dimensionality reduction on a concatenation of a plurality of the first basis matrices to generate a second basis matrix; and
a second decomposition unit performing matrix decomposition on a concatenation of a plurality of the feature matrices using the second basis matrix, thereby generating an activations matrix.

2. The information processing apparatus of claim 1, wherein in the decomposition of the concatenation of the feature matrices, the second decomposition unit fixes basis matrix as the second basis matrix and iteratively updates the activation matrix.

3. The information processing apparatus of claim 1, wherein in the decomposition of the concatenation of the feature matrices, the second decomposition unit initializes basis matrix as the second basis matrix and iteratively updates the basis matrix and the activation matrix.

4. The information processing apparatus of claim 1, wherein the activation matrix generated by the second decomposition unit is used to learn model parameters that are to be used in a test phase of pattern recognition.

5. A method, performed by a computer, comprising:
acquiring a plurality of training data, extracting feature data from each training data, and dividing the plurality of training data using the extracted feature data into a plurality of data clusters;
performing for each data cluster: extracting a feature matrix from the training data in the data cluster; and perform matrix decomposition on the feature matrix to generate a first basis matrix;
performing dimensionality reduction on a concatenation of a plurality of the first basis matrices to generate a second basis matrix; and
performing matrix decomposition on a concatenation of a plurality of the feature matrices using the second basis matrix, thereby generating an activations matrix.

6. The method of claim 5, wherein in the decomposition of the concatenation of the feature matrices, fixing basis matrix as the second basis matrix and iteratively updating the activation matrix.

7. The method of claim 5, wherein in the decomposition of the concatenation of the feature matrices, initializing basis matrix as the second basis matrix and iteratively updating the basis matrix and the activation matrix.

8. The method of claim 5, wherein the generated activation matrix is used to learn model parameters that are to be used in a test phase of pattern recognition.

9. A non-transitory storage medium storing a program causing a computer to execute the method of claim 5.
